(19) United States
(12) Patent Application Publication
(10) Pub. No.: US 2018/0175402 A1
(43) Pub. Date: Jun. 21, 2018

(54) Bipolar Plate of A Flow Battery or a Fuel Cell

(71) Applicant: Chong-Jen Lo, Tainan City (TW)

(72) Inventors: Kuo-En Chang, Tainan City (TW); Kan-Lin Hsueh, Hsinchu City (TW); Cian-Tong Lu, Zhubei City (TW)

(21) Appl. No.: 15/386,033

(22) Filed: Dec. 21, 2016

(51) Int. Cl. H01M 8/0245; H01M 8/0234; H01M 8/0232; H01M 8/0254; H01M 8/18

(52) U.S. Cl. CPC H01M 8/0245; H01M 8/0234; H01M 8/188; H01M 8/0254; H01M 8/0232

(57) ABSTRACT

Disclosed is a bipolar plate of a flow battery or a fuel cell installed on a side of a carbon fiber felt, and the bipolar plate is a metal plate having a corrosion-resistant conductive layer with the corrosion-resistant and conductive functions. The bipolar plate has the features of a small thickness in size and a small resistance in an electron conduction path to improve conductivity and provide the advantages of light weight, easy manufacture, and large-area production.

### BACKGROUND OF THE INVENTION

### Field of the Invention

The present invention relates to a bipolar plate of a flow battery or a fuel cell, and more particularly to the bipolar plate with a small thickness in size and a small resistance in an electron conduction path to improve the conductivity, and the bipolar plate also has the advantages of a light weight, an easy manufacture, and a large-area production.

### Description of the Related Art

With reference to FIG. 1 for a conventional flow battery 1, the flow battery 1 comprises two containers 10, 10a, a battery module 11, and two pumps 12. Wherein, the two containers 10, 10a are filled with an electrolyte 13 separately, and the middle of the interior of the battery module 11 is partitioned by a proton exchange membrane 14 and divided into two parts, and the two parts are respectively and electrically coupled to a power/load, so that two edges of the proton exchange membrane 14 form two electrodes respectively. After the electrolytes 13 in the two containers 10, 10a are driven by the two pumps 12 to enter into the battery module 11, the electrolytes 13 in the two parts of the battery module 11 are separated by the proton exchange membrane 14 to produce an ion exchange, and the aforementioned method is used for storing and discharging electricity.

In FIG. 2, the battery module 11 has a bipolar plate 15 installed therein for connecting the batteries in series and collecting electric current. The bipolar plate 15 has a carbon fiber felt 16 installed on a side of the bipolar plate 15, and the carbon fiber felt 16 is provided for adsorbing the incoming electrolyte 13, and the proton exchange membrane 14 is provided for performing the ion exchange. However, the structure of the conventional bipolar plate 15 as shown in FIG. 3 is made of carbon or graphite, and thus having the advantages of a strong corrosion resistance for materials of this sort and featuring moderate thermal and electrical conductivity, but also having the drawbacks of low strength, high brittleness, large volume, and a high level of difficulty for manufacturing a super thin bipolar plate. After the battery module 11 is formed, the battery module 11 has a large volume.

In view of the aforementioned drawbacks of the prior art, the inventor of the present invention conducted researches and experiments, and finally developed a bipolar plate of a flow battery or a fuel cell in accordance with the present invention to overcome the drawbacks of the prior art.

### SUMMARY OF THE INVENTION

Therefore, it is a primary objective of the present invention to provide a bipolar plate has the features of a small thickness in size and a small resistance in an electron conduction path to improve conductivity and provide the advantages of light weight, easy manufacture, and large-area production.

To achieve the aforementioned and other objectives, the present invention discloses a bipolar plate of a flow battery or a fuel cell, and the bipolar plate is made of a metal plate, and a corrosion-resistant conductive layer with the corrosion-resistant and conductive function is coated onto an outer wall of the bipolar plate. The improved bipolar plate has the following features and advantages.

The bipolar plate has both left and right sides bent to form a plurality of flow paths.

The bipolar plate is a meshed metal bipolar plate.

The metal bipolar plate is adhered with a carbon fiber felt, a carbon paper, and a porous carbon material by a corrosion-resistant conductive adhesive and integrally formed.

### BRIEF DESCRIPTION OF THE DRAWINGS

FIG. 1 is a schematic view of the structure of a conventional flow battery;

FIG. 2 is a schematic view of a plurality of conventional batteries connected in series with one another;

FIG. 3 is a perspective view of a conventional bipolar plate;

FIG. 4 is a schematic view of a bipolar plate installed to a battery module having a plurality of batteries connected in series with each other in accordance with a first embodiment of the present invention;

FIG. 5 is a partial blowup view of FIG. 4;

FIG. 6 is a partial blowup view of a bipolar plate in accordance with a second embodiment of the present invention;

FIG. 7 is a partial blowup view of a bipolar plate in accordance with a third embodiment of the present invention;

FIG. 8 is partial blowup view of a bipolar plate and a carbon fiber felt integrally formed with each other in accordance with the second embodiment of the present invention; and

FIG. 9 is a partial blowup view of a bipolar plate and a carbon fiber felt integrally formed with each other in accordance with the third embodiment of the present invention.

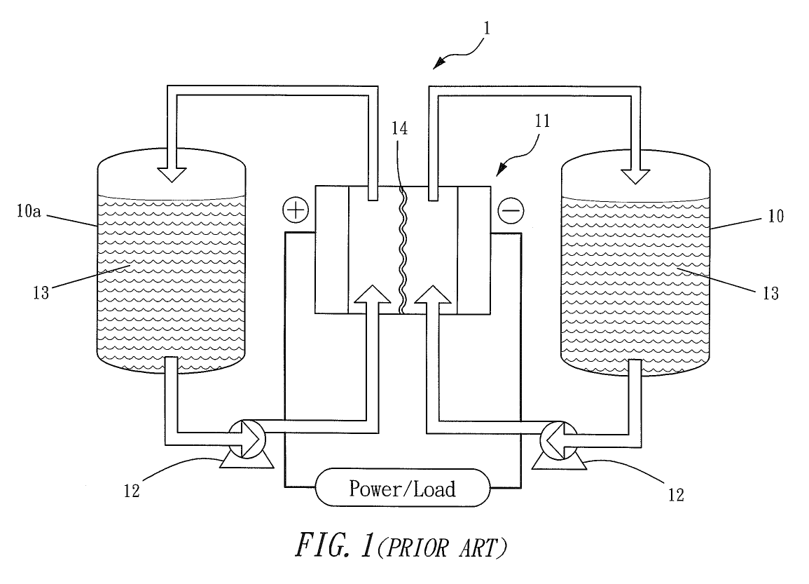

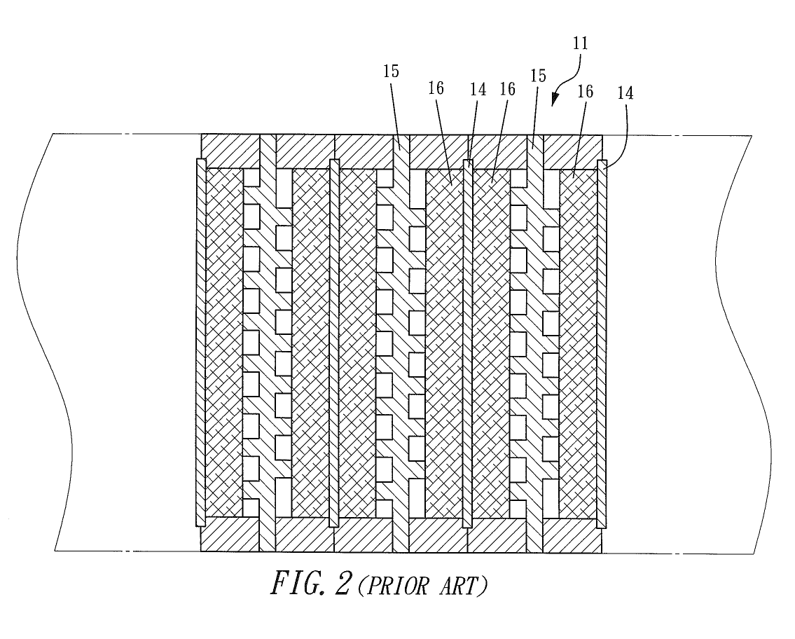

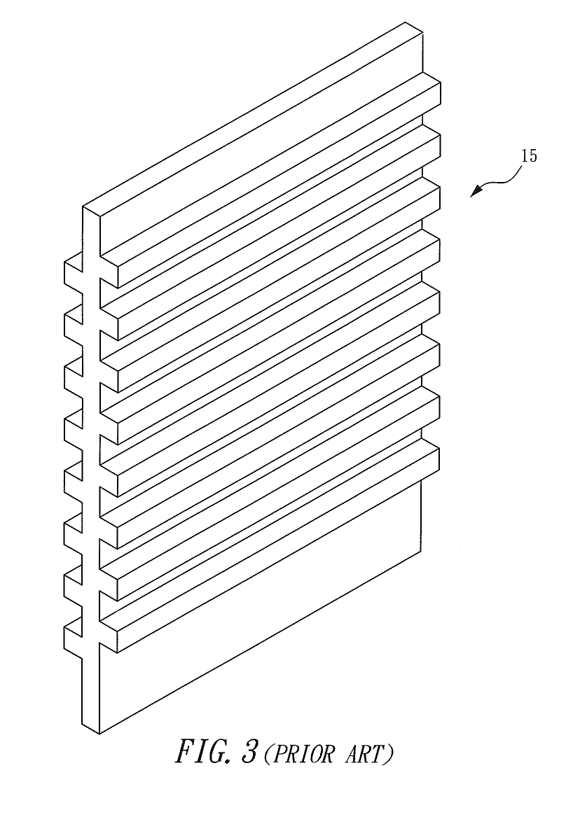

### DETAILED DESCRIPTION OF THE PREFERRED EMBODIMENTS

The technical characteristics, contents, advantages and effects of the present invention will be apparent with the detailed description of a preferred embodiment accompanied with related drawings as follows.

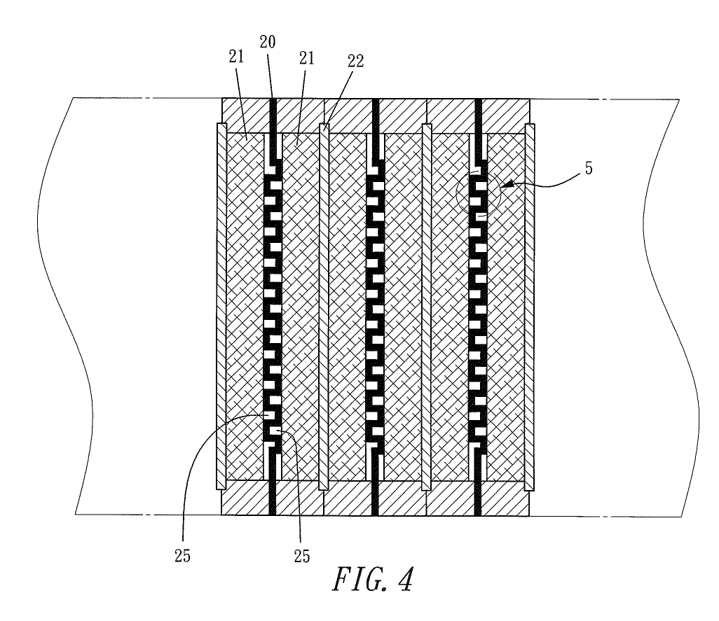

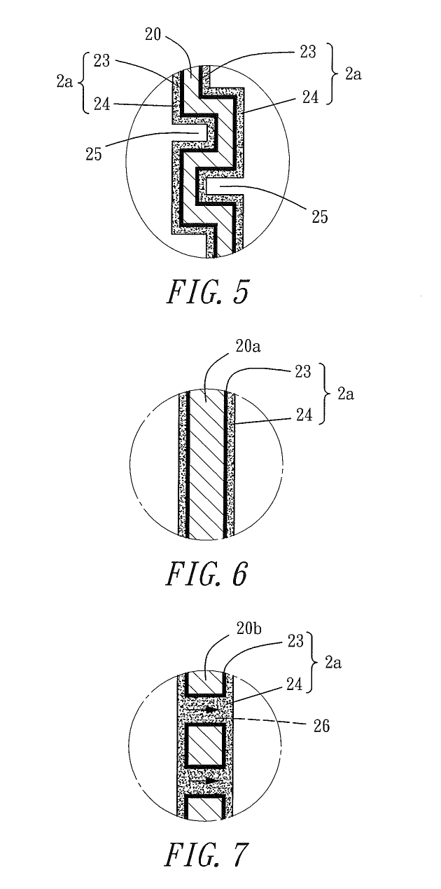

With reference to FIGS. 4 and 5 for a bipolar plate 20 in accordance with the first embodiment of the present invention, the bipolar plate 20 is installed on a side of a carbon fiber felt 21, and two adjacent carbon fiber felts 21 are separated by a proton exchange membrane 22. The bipolar plate 20 is a metal plate and both left and right sides of the bipolar plate 20 are bent to form a plurality of flow paths 25, and the flow path 25 has an opening aligned towards a horizontal outer side and provided as a flow path 25 for entering an electrolyte into a battery module, so that the electrolyte flows towards the carbon fiber felt 21 at the edges of the metal plate 20 and wets the carbon fiber felt 21. A corrosion-resistant conductive layer 2a with the corrosion-resistant and conductive functions is coated onto an outer wall of the bipolar plate 20. In the process of coating the corrosion-resistant conductive layer 2a, a corrosion-resistant layer 23 is coated first (as shown in FIG. 5), and then a conductive layer 24 is coated onto the corrosion-resistant layer 23, so that the bipolar plate 20 is isolated from the electrolyte to prevent corrosion while providing the electrical conductivity.

The bipolar plate 20 is made of aluminum, iron, copper, chromium, titanium and their alloys, or stainless steel.

The corrosion-resistant layer 23 has a coating material made of a resin.

The conductive layer 24 has a coating material made of a composite material including a carbon powder, a carbon fiber, and a resin.

With reference to FIG. 6 for a bipolar plate 20a in accordance with the second embodiment of the present invention, the difference between bipolar plate 20a of this embodiment and the bipolar plate 20 of the first embodiment resides on that the bipolar plate 20a has a plate structure and does not have any flow path, and the coating structure is the same as the first embodiment, and thus will not be repeated.

With reference to FIG. 7 for a bipolar plate 20b in accordance with the third embodiment of the present invention, the difference between this embodiment and the second embodiment resides on that the bipolar plate 20b has a meshed setting with a plurality of meshes (holes) 26, and the mesh has the corrosion-resistant conductive layer 2a (the corrosion-resistant layer 23 and the conductive layer 24) disposed on a hole wall of the mesh 26, and the conductive layer 24 or corrosion-resistant conductive layer 2a filled up in the mesh 26. With the conductive layer 24 or corrosion-resistant conductive layer 2a set in the mesh 26, the resistance of the electron conduction path is decreased, and the conductivity is increased. Further, the left and right sides of the meshed bipolar plate 20b are bent to form a plurality of flow paths 25 as shown in FIGS. 4 and 5.

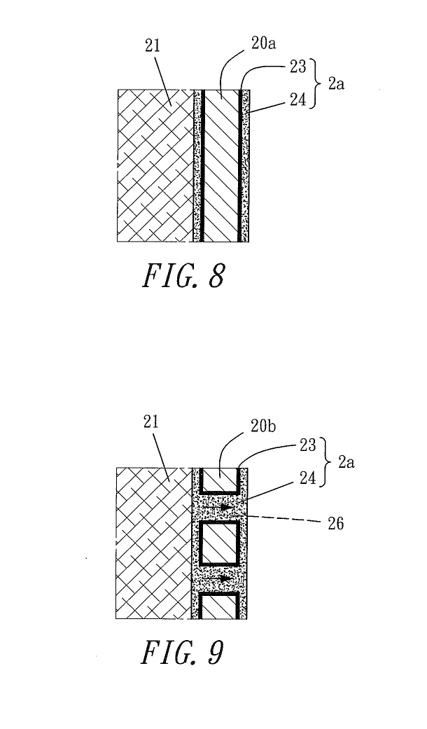

The bipolar plates 20, 20a, 20b of the aforementioned three embodiment of the present invention are integrally formed with the carbon fiber felt 21. Since the conductive layer 24 (formed on the outer side of the bipolar plate) of the present invention is made a composite material including a carbon powder, a carbon fiber, and a resin, therefore a conductive adhesive may be used to adhere the bipolar plate with the carbon fiber felt 21 as a whole without applying external force to reduce the interface impedance. Wherein, the conductive adhesive is a corrosion-resistant conductive material made by mixing composite materials including a carbon powder, a carbon fiber, and a resin. FIG. 8 is a schematic view showing the bipolar plate 20a and the carbon fiber felt 21 integrally formed with each other in accordance with the second embodiment of the present invention and FIG. 9 is a schematic view showing the bipolar plate 20b and the carbon fiber felt 21 integrally formed with each other in accordance with the third embodiment of the present invention.

Therefore, the present invention at least has the following advantages and effects:

1. The bipolar plate is made of metal and the corrosion-resistant conductive layer (including the corrosion-resistant layer and the conductive layer) is coated on an outer surface of the bipolar plate, so that the bipolar plate is not in contact with the electrolyte to prevent corrosion while providing a good conductivity. The bipolar plate has the features of small thickness, light weight, easy manufacture, and large-area production.

2. The bipolar plate is in a meshed form and the conductive layer is coated into the mesh, so that the resistance of the electron conduction path is small to improve the conductivity.

3. The bipolar plate may be integrally formed with the carbon fiber felt, so as to reduce the interface impedance without the need of applying external forces.

In summation of the above description, the present invention herein enhances the performance than the conventional structure and further complies with the patent application requirements and is submitted for patent application. While the invention has been described by means of specific embodiments, numerous modifications and variations could be made thereto by those skilled in the art without departing from the scope and spirit of the invention set forth in the claims.

What is claimed is:

1. A bipolar plate of a flow battery or a fuel cell installed on a carbon fiber felt side of the battery or cell, characterized in that the bipolar plate is made of a metal plate, and a corrosion-resistant conductive layer with the corrosion-resistant and conductive function is coated onto an outer wall of the bipolar plate.

2. The bipolar plate of a flow battery or a fuel cell according to claim 1, wherein the bipolar plate has both left and right sides bent to form a plurality of flow paths, and the flow path have an opening aligned towards a horizontal outer side.

3. The bipolar plate of a flow battery or a fuel cell according to claim 1, wherein the bipolar plate has a meshed setting with a plurality of meshes, and the mesh has the corrosion-resistant conductive layer disposed on a hole wall of the mesh, and the corrosion-resistant conductive layer filled up in the mesh.

4. The bipolar plate of a flow battery or a fuel cell according to claim 1, wherein the corrosion-resistant conductive layer is formed by coating a corrosion-resistant layer onto an outer wall of the metal plate first, and then coating a conductive layer onto the corrosion-resistant layer.

5. The bipolar plate of a flow battery or a fuel cell according to claim 4, wherein the corrosion-resistant layer has a coating material made of a resin.

6. The bipolar plate of a flow battery or a fuel cell according to claim 4, wherein the conductive layer has a coating material made of a composite material including a carbon powder, a carbon fiber, and a resin.

7. The bipolar plate of a flow battery or a fuel cell according to claim 3, wherein the bipolar plate is bent from both left and right sides to form a plurality of flow paths.

8. The bipolar plate of a flow battery or a fuel cell according to claim 1, wherein the bipolar plate is adhered by a conductive adhesive and integrally formed, and the conductive adhesive is a corrosion-resistant conductive material manufactured by mixing composite materials including a carbon powder, a carbon fiber, and a resin.

9. The bipolar plate of a flow battery or a fuel cell according to claim 2, wherein the bipolar plate is adhered by a conductive adhesive and integrally formed, and the conductive adhesive is a corrosion-resistant conductive material manufactured by mixing composite materials including a carbon powder, a carbon fiber, and a resin.

10. The bipolar plate of a flow battery or a fuel cell according to claim 3, wherein the bipolar plate is adhered by a conductive adhesive and integrally formed, and the conductive adhesive is a corrosion-resistant conductive material manufactured by mixing composite materials including a carbon powder, a carbon fiber, and a resin.

11. The bipolar plate of a flow battery or a fuel cell according to claim 1, wherein the bipolar plate is made of a material selected from a group consisting aluminum, iron, copper, chromium, titanium, and an alloy thereof, or stainless steel.
